(19) United States
(12) Patent Application Publication
(10) Pub. No.: US 2003/0185251 A1
(43) Pub. Date: Oct. 2, 2003

(54) Multiplex transmission system capable of using ordinary network packets to transmit a plurality of 8B/10B bit streams

(75) Inventors: Kiyohisa Ichino, Tokyo (JP); Satoshi Kamiya, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/390,471

(22) Filed: Mar. 17, 2003

(30) Foreign Application Priority Data
Mar. 28, 2002 (JP) 2002-091670

(51) Int. Cl. H04J 3/04

(52) U.S. Cl. 370/535

(57) ABSTRACT

A multiplex transmission system transmits a plurality of 8B/10B bit streams using ordinary network packets. A multiplex converter subjects a plurality of 8B/10B bit streams to 8B/10B decoding, performs 64B/65B encoding and then multiplexing, adds 7-bit CRC, then adds necessary overhead to construct packets, and finally, sends the packets on a packet transmission path. An demultiplex converter removes the overhead from packets that have been received from the packet transmission path, uses the CRC to detect bit errors, carries out 64B/65B decoding, rate regulation, and 8B/10B encoding to restore to the original 8B/10B bit streams and sends the 8B/10B bit streams to respective channels.

### BACKGROUND OF THE INVENTION

1. Field of the Invention

The present invention relates to a multiplex transmission system that is constructed from a multiplex converter for multiplexing a plurality of 8B/10B bit streams and converting to packet data and an demultiplex converter for separating and restoring the 8B/10B bit streams from packet data that have been multiplexed by the multiplex converter.

2. Description of the Related Art

In recent years, fiber channels are being used as interfaces for forming connections between external storage devices as well as between storage devices and computers. Such fiber channels are a high-speed data communication technology that has been standardized by the American National Standards Institute (ANSI) and that has received widespread attention due to its potential for cutting costs and offering a real-time network environment.

8B/10B block encoding is adopted on the physical layer of these fiber channels. Details regarding 8B/10B block encoding are described in ANSI X3.230. In addition to fiber channels, protocols that use 8B/10B block encoding include SBCON (ANSI X3.296), Gigabit Ethernet (IEEE 802.3), and DVB-ASI (ETSI (CENELEC) EN 50083-9).

In 8B/10B block encoding, every eight bits of data that are in units of eight bits are converted to ten bits of code in accordance with prescribed encoding rules. The original eight bits are referred to as a byte, and the ten bits of code to which a byte is converted is called a character. In this specification, the former is referred to as an 8B byte and the latter is referred to as a 10B character.

According to 8B/10B encoding rules, the same code is not repeated more than six times in a signal of 10B characters. In 8B/10B encoding rules, moreover, two 10B characters having reciprocal numbers of “0” and “1” are determined for each 8B byte. One of these two 10B characters is selected according to the number of “0” and “1” in the preceding 10B character. The large number of change points that consequently occur in 10B character signals facilitates the extraction of clocks and data on the receiving side.

The 10B characters of 8B/10B block codes are defined to allow the representation of 256 types of data codes and 12 types of control codes. Data codes are normally expressed as Dxx.y and control codes are expressed as Kxx.y. Each data code corresponds to one of 256 8B Bytes that are represented by eight bits. Sets of ten bits that are not used as data codes are assigned to control codes. Control codes are used for transmitting control information such as patterns for character synchronization and link breaks. 8B/10B block encoding allows both the transparent transmission of data as well as the transmission of various control information.

When transmitting a plurality of 8B/10B bit streams composed of data that have been subjected to this 8B/10B encoding, the prior art adopted an approach in which the plurality of 8B/10B bit streams are each transmitted using independent lines.

This approach necessitated lines for transmitting 8B/10B bit streams in addition to the normal packet network. The number of lines required depends on the number of 8B/10B bit streams, and increase in the number of lines is attended by a corresponding increase in equipment.

### SUMMARY OF THE INVENTION

It is an object of the present invention to provide a device that is capable of using normal network packets for transmitting a plurality of 8B/10B bit streams without necessitating dedicated lines.

To achieve the above-described object, the multiplex transmission system of the present invention is composed of a multiplex converter and an demultiplex converter. The multiplex converter converts each of a plurality of 8B/10B bit streams, which are serial signals, to 10-bit parallel signals to produce code words; subjects each of these code words to 8B/10B decoding to produce 9-bit byte data, and subjects these byte data to 64B/65B encoding to produce 65-bit 65B blocks. After implementing rate conversion for this plurality of 65B blocks, the multiplex converter then multiplexes these blocks to produce a single 65B block and calculates a 7-bit CRC for this 65B block. Finally, the multiplex converter adds this CRC to the 65B block to produce a 72B block, adds the necessary overhead for every fixed number of 72B blocks to construct packets, and transmits these packets to a packet transmission path.

In specific terms, this multiplex converter is composed of a plurality of deserializers, a plurality of 8B/10B decoders, a plurality of 64B/65B encoders, a plurality of rate conversion memories, a channel multiplexer, a CRC operation unit, a packet generator, and a packet transmitter.

The plurality of deserializers convert each of the plurality of 8B/10B bit streams, which are serial signals, to respective 10-bit parallel signals and supply the resulting output as code words. The plurality of 8B/10B decoders decode the code words from the plurality of deserializers and supply the result as 9-bit byte data.

The plurality of 64B/65B encoders subject the byte data from the plurality of 8B/10B decoders to 64B/65B encoding and supply the resulting output as 65-bit 65B blocks. The plurality of rate conversion memories first store each of the 65B blocks from the plurality of 64B/65B encoders, and upon receiving a read request, sequentially supply 65B blocks that are stored if 65B blocks are stored, and if 65B blocks are not stored, supply 65B blocks that include control codes for filling the bandwidth difference.

The channel multiplexer multiplexes the 65B blocks of the plurality of channels that are supplied from the plurality of rate conversion memories to produce one 65 block and supplies the result as output. The CRC operation unit calculates 7-bit CRC for the 65B blocks from the channel multiplexer, adds this CRC to the 65B blocks from the channel multiplexer, and supplies the result as 72B blocks.

The packet generator both adds the necessary overhead to a fixed number of 72B blocks from the CRC operation unit to construct packets and issues read requests to the rate conversion memories. The packet transmitter controls the physical media and links of a packet transmission path and transmits packets that have been generated by the packet generator to a packet transmission path.

The demultiplex converter removes overhead from packets that have been received from a packet transmission path to extract 72B blocks, uses the CRC that have been added to these 72B blocks to detect bit errors, and then subjects the 65B blocks that are obtained by eliminating CRC from the above-described 72B blocks to 64B/65B decoding to obtain byte data. The demultiplex converter then distributes these byte data according to channel number to produce a plurality of items of byte data that correspond to each of the plurality of channels, determines whether this plurality of items of byte data match control codes for filling the bandwidth difference, and removes the byte data when matching occurs. The demultiplex converter then regulates the rate of this plurality of byte data by removing byte data that can be removed without causing protocol problems or inserting byte data that can be inserted without causing protocol problems, subjects the byte data that have undergone the rate regulation to 8B/10B encoding to generate code words, subjects each of these code words to serial conversion and then supplies the result to each channel as 8B/10B bit streams.

In specific terms, the demultiplex converter is composed of a packet receiver, a 72B block extractor, a CRC detector, a 64B/65B decoder, a channel separator for supplying output as a plurality of items of byte data, a plurality of PAD elimination units, a plurality of idle elimination units, a plurality of rate conversion memories, a plurality of idle insertion units, a plurality of 8B/10B encoders, and a plurality of serializers.

The packet receiver controls the links and physical media of packet transmission paths and receives packets from a packet transmission path. The 72B block extractor removes overhead from packets that have been received by the packet receiver to extract 72B blocks, and supplies these 72B blocks together with channel numbers, which are the numbers of the channels to which these 72B blocks belong.

The CRC detector uses CRC that are attached to the 72B blocks from the 72B block extractor to detect bit errors and then supplies as output 65B blocks, which are obtained by removing CRC from 72B blocks, and channel numbers, which are the numbers of the channels to which these 65B blocks belong.

The 64B/65B decoder subjects the 65B blocks from the CRC detector to 64B/65B decoding to supply byte data and channel numbers. The channel separator distributes the byte data from the 64B/65B decoder in accordance with the channel numbers and supplies the result as a plurality of items of byte data that correspond to the plurality of channels.

The plurality of PAD elimination units determine whether the plurality of items of byte data from the channel separator matches control codes for filling bandwidth difference, and when matching occurs, eliminates the matching byte data. The plurality of idle elimination units eliminate byte data for which elimination causes no protocol problems when the data storage amount that is reported from the outside exceeds a predetermined threshold and supplies the remaining byte data as output.

The plurality of rate conversion memories first store each of the items of byte data from the idle elimination units and, upon receiving a read request, both sequentially supply as output the byte data that are stored and report the current data storage amount to the idle elimination units. When the data storage amount from the rate conversion memories falls below a predetermined threshold, the plurality of idle insertion units both insert byte data whose insertion does not cause protocol problems into the byte data from the rate conversion memories and, while inserting these byte data, halt the issuance of read requests to the rate conversion memories.

The plurality of 8B/10B encoders subject the byte data from the idle insertion units to 8B/10B encoding to generate code words. The plurality of serializers subject the code words from the plurality of 8B/10B encoders to serial conversion and supply the result as 8B/10B bit streams to each channel.

The multiplex transmission system of the present invention converts a plurality of 8B/10B bit streams to a format that can be transmitted on a packet network, whereby an 8B/10B bit stream transmission service can be offered in addition to a normal packet transmission service by constructing a single packet network. The present invention therefore enables the sharing of network lines and equipment and a consequent increase in the efficiency of the use of these lines and equipment. In addition, multiplexing a plurality of 8B/10B bit streams onto a single line allows a decrease of the lines and equipment that are required for transmitting a plurality of 8B/10B bit streams. Finally, transmitting on the code word level without terminating the host layer of the 8B/10B bit streams enables the transparent transmission of 8B/10B bit streams.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a block diagram showing the construction of a multiplex transmission system according to the first embodiment of the present invention;

FIG. 2 is a block diagram showing the construction of multiplex converter 1 in FIG. 1;

FIG. 3 is a block diagram showing the construction of demultiplex converter 2 in FIG. 1;

FIG. 4 shows an example of a conversion table for converting code words to 9-bit data;

FIG. 5 shows an example of 64B/65B encoding;

FIG. 6 shows the composition of packets that are generated by a multiplex converter;

FIG. 7 shows an example of the elimination of idle data; and

FIG. 8 shows an example of the insertion of idle data.

### DETAILED DESCRIPTION OF THE PREFERRED EMBODIMENTS

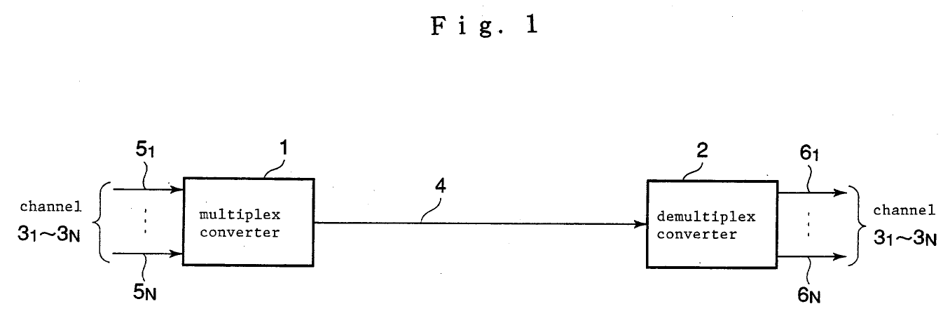

We first refer to FIG. 1, in which is shown a multiplex transmission system according to the first embodiment of the present invention. As shown in FIG. 1, the multiplex transmission system of the present embodiment is composed of multiplex converter 1 and demultiplex converter 2, this multiplex converter 1 and demultiplex converter 2 being connected together by means of packet transmission path 4.

Multiplex converter 1 constructs packets by multiplexing 8B/10B bit streams 5₁-5_{N} that flow on N channels 3₁-3_{N} (where N is equal to or greater than 1) and supplies these packets as output to packet transmission path 4. Inverse multiplex converter 2 reproduces 8B/10B bit streams 6₁-6_{N} from the packets that it receives from packet transmission path 4 and supplies each of the bit streams to the N corresponding channels 3₁-3_{N}.

In the present embodiment, channels 3₁-3_{N} are assumed to be all of the same type and rate. In addition, packet transmission path 4 is assumed to be constantly able to provide the necessary bandwidth regardless of the content of the transmitted packets.

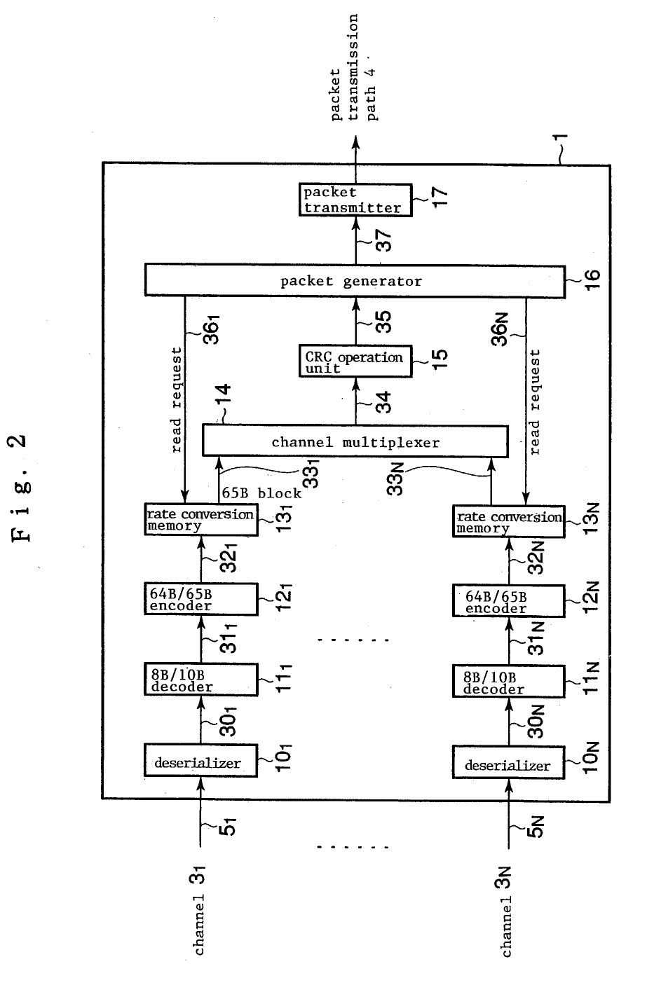

Referring now to FIG. 2, we next describe the details of the construction of multiplex converter 1 that is shown in FIG. 1. As shown in FIG. 2, multiplex converter 1 is composed of: deserializers 10₁-10_{N}, 8B/10B decoders 11₁-11_{N}, 64B/65B encoders 12₁-12_{N}, rate conversion memories 13₁-13_{N}, channel multiplexer 14, CRC (Cyclic Redundancy Code) operation unit 15, packet generator 16, and packet transmitter 17.

Deserializer 10_{X} (where 1≦X≦N) converts 8B/10B bit stream 5_{X}, which is a serial signal, to a 10-bit parallel signal and supplies code word 30_{X} as output. 8B/10B decoder 11_{X} (where 1≦X≦N) performs 8B/10B decoding of code word 30_{X} and supplies 9-bit byte data 31_{X} as output. The most significant bit of byte data 31_{X} indicates the type of byte data, this bit being “0” when indicating data code (Dx, y) and “1” when indicating control code (for example, Kx, y). The eight lower-order bits of the nine bits accommodate 256 types of data code or 14 types of control code. 64B/65B encoder 12_{X} (where 1≦X≦N) subjects byte data 31_{X} to 64B/65B encoding and supplies the result as 65-bit 65B blocks 32_{X}.

Rate conversion memory 13_{X} (where 1≦X≦N) is a FIFO (First-In/First-Out) memory for converting the rate from the clock of channel 3_{X} to the clock of packet transmission path 4. 65B block 32_{X} is written to rate conversion memory 13_{X}. 65B block 33_{X} is then read from rate conversion memory 13_{X} if read request 36_{X} is issued from packet generator 16. When rate conversion memory 13_{X} is empty, however, 65B block 33_{X} that contains control code “65B_PAD” is supplied as output for filling the bandwidth difference.

Essentially, rate conversion memory 13_{X} first stores 65B blocks from 64B/65B encoder 12_{X}, and upon receiving read request 36_{X} as input, sequentially supplies stored 65B blocks as output if 65B blocks are stored, and supplies 65B blocks containing control code “65B_PAD” as output if 65B blocks are not stored.

Channel multiplexer 14 multiplexes 65B blocks 33₁-33_{N} and supplies the result as 65B block 34. CRC operation unit 15 calculates a 7-bit CRC for 65B blocks 34 and attaches the CRC to the end of 65B blocks 34 to generate 72B blocks 35. Packet generator 16 adds necessary overhead (such as headers) to a fixed number of 72B blocks 35 to construct packets 37. Packet generator 16 also issues read requests 36_{X} to rate conversion memory 13_{X} (where 1≦X≦N). Packet transmitter 17 controls the links and physical media of packet transmission path 4 and transmits packets 37 to packet transmission path 4.

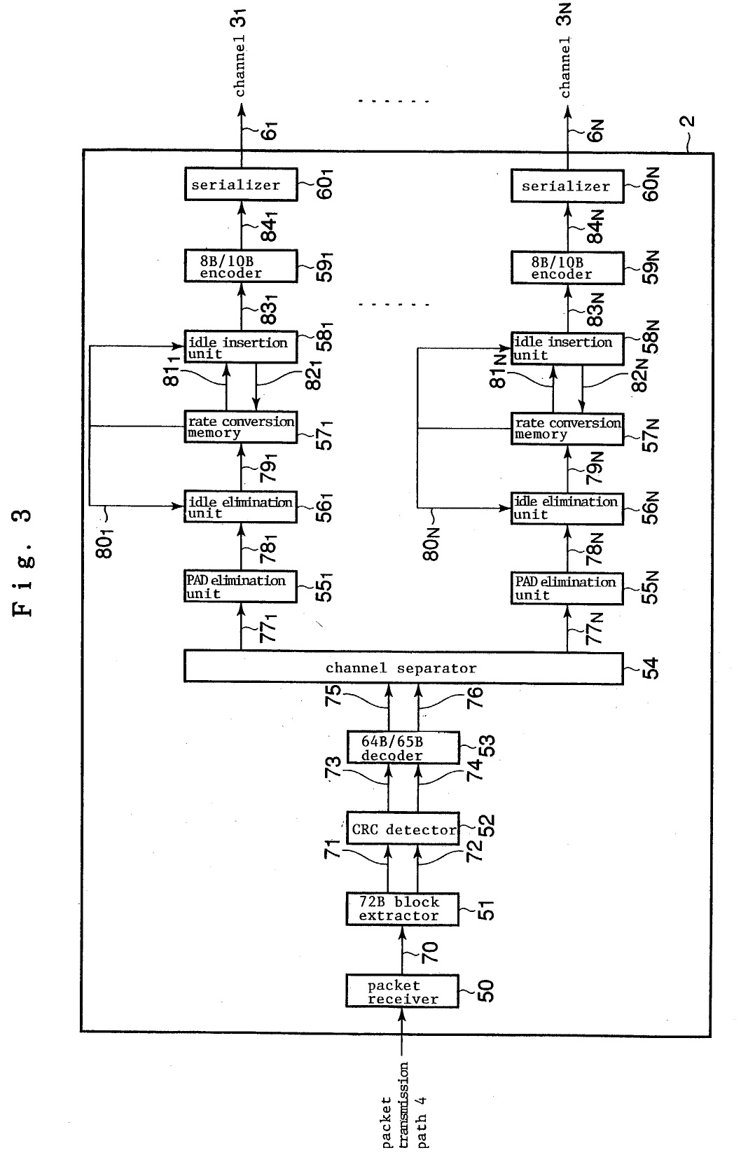

We next refer to FIG. 3 to explain the details of the construction of demultiplex converter 2 in FIG. 1.

As shown in FIG. 3, demultiplex converter 2 is composed of packet receiver 50, 72B block extractor 51, CRC detector 52, 64B/65B decoder 53, channel separator 54, PAD elimination units 55₁-55_{N}, idle elimination units 56₁-56_{N}, rate conversion memories 57₁-57_{N}, idle insertion units 58₁-58_{N}, 8B/10B encoders 59₁-59_{N}, and serializers 60₁-60_{N}.

Packet receiver 50 controls the links and physical media of packet transmission path 4 and receives packets 70 from packet transmission path 4. 72B block extractor 51 removes the overhead from packets 70 to extract 72B blocks 71. 72B block extractor 51 further supplies channel numbers 72 that indicate which of channels 3₁-3_{N} the 72B blocks 71 belong to. CRC detector 52 uses the CRC that is attached to 72B blocks 71 to detect bit errors. Error correction may also be performed at this time. The output of CRC detector 52 is 65B blocks 73 and channel numbers 74. Channel numbers 74 are the numbers of channels 3₁-3_{N} to which 65B blocks 73 belong.

64B/65B decoder 53 subjects 65B blocks 73 to 64B/65B decoding and supplies byte data 75 and channel numbers 76 as output. Channel numbers 76 are the numbers of channels 3₁-3_{N} to which byte data 75 belong. Channel separator 54 distributes byte data 75 in accordance with channel numbers 76 and supplies the output byte data 77₁-77_{N}. PAD elimination unit 55_{X} (where 1≦X≦N) determines whether byte data 77_{X} match with the control code “65B_PAD,” and if matching occurs, removes the byte data. The output of PAD elimination unit 55_{X} is byte data 78_{X}.

Idle elimination unit 56_{X} (where 1≦X≦N) removes byte data 78_{X} for which elimination does not cause protocol problems. However, this elimination is carried out only as long as data storage amount 80_{X} exceeds a threshold value. Here, data storage amount 80_{X} is the number of items of byte data that are stored in rate conversion memory 57_{X}. Byte data 78_{X} that cannot be removed are supplied as byte data 79_{X}.

Rate conversion memory 57_{X} (where 1≦X≦N) is a FIFO memory for effecting rate conversion from the clock on the side of packet transmission path 4 to the clock on the side of channel 3_{X}. Byte data 79_{X} are first written to rate conversion memory 57_{X}. When read request 82_{X} is issued, byte data 81_{X} are read out. Finally, rate conversion memory 57_{X} provides data storage amount 80_{X} to idle elimination unit 56_{X} and idle insertion unit 58_{X}.

Essentially, rate conversion memory 57_{X} first stores byte data from idle elimination unit 56_{X}, and upon receiving read request 82_{X} from idle insertion unit 58_{X}, sequentially supplies the byte data that are stored. Idle insertion unit 58_{X} (where 1≦X≦N) inserts byte data whose insertion does not cause protocol problems into byte data 83_{X}. This insertion is carried out as long as data storage amount 80_{X} is below a threshold value. During insertion, the issuance of read request 82_{X} is halted, and the reading of byte data 81_{X} from rate conversion memory 57_{X} is prevented. Idle insertion unit 58_{X} issues a read request 82_{X} when this insertion process is not being carried out, and supplies byte data 81_{X} that are read from rate conversion memory 57_{X} as byte data 83_{X}.

8B/10B encoder 59_{X} (where 1≦X≦N) subjects byte data 83_{X} to 8B/10B encoding to generate code words 84_{X}. Serializer 60_{X} (where 1≦X≦N) subjects code words 84_{X} from 8B/10B encoder 59_{X} to serial conversion and supplies the result to channel 3_{X} as 8B/10B bit stream 6_{X}.

We next refer to the figures to describe details regarding the operation of the multiplex transmission system of the present embodiment.

We first refer to FIG. 2 to describe the operation of multiplex converter 1.

8B/10B bit stream 5_{X} (where 1≦X≦N) is applied as input to deserializer 10_{X} and parallel-developed in 10-bit units. Here, the boundaries of the 10-bit units are recognized by means of specific bit patterns referred to as commas. The parallel-developed 10-bit data become code words 30_{X} and are sent to 8B/10B decoder 11_{X}.

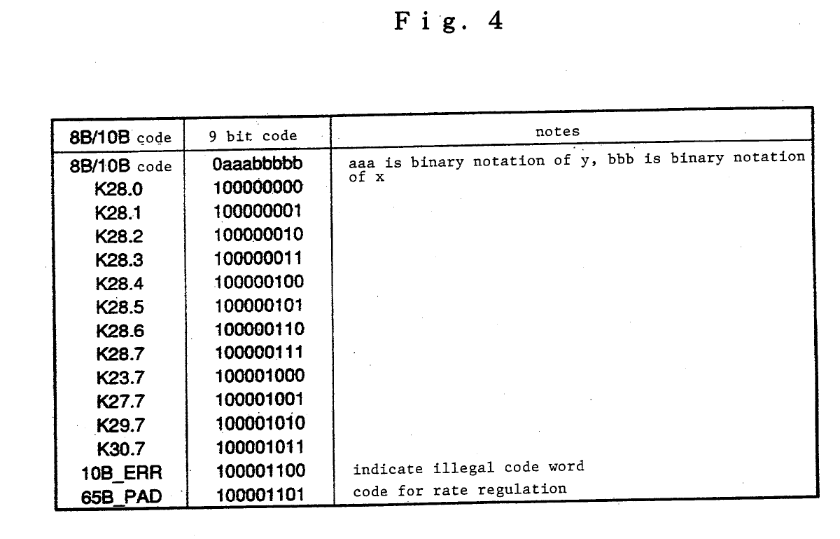

After undergoing 8B/10B decoding in 8B/10B decoder 11_{X}, code words 30_{X} (where 1≦X≦N) are converted to 9-bit byte data 31_{X} in accordance with the table shown in FIG. 4. FIG. 4 is taken from the GFP (Generic Framing Procedure) standards (ITU-T G. 7041), but any relation other than the relation shown in FIG. 4 may be adopted as long as a one-to-one correspondence is established between code words and byte data. When code words 30_{X} cannot undergo 8B/10B decoding, control code “10B_ERR” indicating an illegal code word is supplied as output. Control code “10B_ERR” is used for reporting the occurrence of an 8B/10B decoding error to demultiplex converter 2.

Byte data 31_{X} (where 1≦X≦N) are encoded to 65B block 32_{X} in 64B/65B encoder 12_{X}. This encoding is established in the GFP standards and is referred to as “64B/65B encoding.”

64B/65B encoding is next described with actual examples. 64B/65B encoding is a method of encoding eight bytes of data into a 65-bit 65B block. First, regarding the composition of a 65B block, the first bit of a 65B block is a flag bit, this bit being “0” only when all received eight bytes of data are data code. The 64-bit region from the second to the 65^{th} bits of a 65B block is divided into eight octets. For the sake of expedience, the eight bits from the second bit to the ninth bit of the 65B block are the first octet, the tenth to 17^{th} bits are the second octet, and so on. The received eight bytes of data are stored in respective octets. However, The order in which the eight bytes of data are received does not necessarily match the arrangement of the first to eighth octets. Byte data that represent control codes are stored in order from the first octet regardless of the order of input.

Octets in which data codes are stored accommodate the eight lower-order bits of byte data. Octets in which control codes are stored are further divided into three areas, the first area being the Last Control Character located at the first bit of the octet. The Last Control Character is “1” if control code is stored in the next octet, and the Last Control Character is “0” when data code is stored in the next octet or when the current octet is the last octet (the eighth octet). The second area is the Control Character Locator and is assigned to the three bits from the second bit to the fourth bit of the octet. The Control Character Locator indicates the original location of the control code that is stored in this octet. The original location is represented by numerical values starting from 0 in the time series order of the received eight bytes of data. For example, if the Control Character Locator is “6,” the control code was located at the seventh of the eight bytes of data before 64B/65B encoding. The third area is the Control Character Indicator and is assigned to the four bits from the fifth to the eighth bits of the octet. The Control Character Indicator accommodates four lower-order bits of byte data that are stored in this octet.

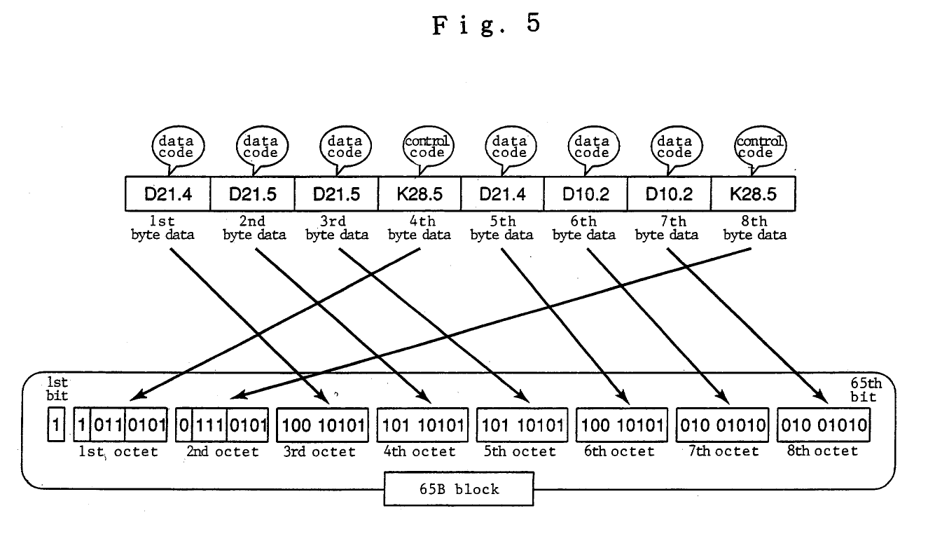

Referring now to FIG. 5, we examine an actual example of 64B/65B encoding. In the present example, we will describe the process for encoding, into a 65B block, eight bytes of data of the time series:

| | |
|---|---|
| First byte of data = | 010010101 |
| | (binary number, data code D21.4) |
| Second byte of data = | 010110101 |
| | (binary number, data code D21.5) |
| Third byte of data = | 010110101 |
| | (binary number, data code D21.5) |
| Fourth byte of data = | 100000101 |
| | (binary number, control code K28.5) |
| Fifth byte of data = | 010010101 |
| | (binary number, data code D21.4) |
| Sixth byte of data = | 001001010 |
| | (binary number, data code D10.2) |
| Seventh byte of data = | 001001010 |
| | (binary number, data code D10.2) |
| Eighth byte of data = | 100000101 |
| | (binary number, control code K28.5) |

The correspondence between octets and each of the bytes of data is first determined. As previously described, the byte data that represent control codes are stored in order from the first octet, resulting in the following correspondences:

| | |
|---|---|
| The first octet corresponds to the fourth byte of data | (Control code) |
| The second octet corresponds to the eighth byte of data | (Control code) |
| The third octet corresponds to the first byte of data | (Data code) |
| The fourth octet corresponds to the second byte of data | (Data code) |
| The fifth octet corresponds to the third byte of data | (Data code) |
| The sixth octet corresponds to the fifth byte of data | (Data code) |
| The seventh octet corresponds to the sixth byte of data | (Data code) |
| The eighth octet corresponds to the seventh byte of data | (Data code) |

Next, the flag bit of the 65B block is found. Since control codes are included within the eight bytes of data, the flag bit is 1. Next, the Last Control Character, the Control Character Locator, and the Control Character Indicator of the octets in which control codes are stored are found. Based on the definitions for each of these items, these values are:

| | |
|---|---|
| First octet, Last Control Character = | 1 |
| Second octet, Last Control Character = | 0 |
| First octet, Control Character Locator = | 3 |
| Second octet, Control Character Locator = | 7 |
| First octet, Control Character Indicator = | 0101 (Binary) |
| Second octet, Control Character Indicator = | 0101 (Binary) |

This completes the 64B/65B encoding, and the obtained 65B block is:

1 10110101 01110101 10010101 10110101 10110101 10010101 01001010 01001010 (Binary)

65B block 32_{X} (where 1≦X≦N) is written to rate conversion memory 13_{X}. If read request 36_{X} is not issued, all of the bits of 65B block 33_{X} are made “0.” On the other hand, if read request 36_{X} is issued, 65B block 33_{X} is read from rate conversion memory 13_{X}, whereupon, if rate conversion memory 13_{X} is empty, 65B block 33_{X} containing eight control codes “65B_PAD” is supplied as output. This 65B block is subsequently referred to as a “padding block.” Padding blocks are inserted for absorbing the difference between the total rate of channels 3₁-3_{N} and the bandwidth of packet transmission path 4. In other words, the number of padding blocks that are inserted is equal to “(the bandwidth of packet transmission path 4)−(the total rate of channels 3₁-3_{N}).” The bit pattern of a padding block is as follows:

1 10001101 10011101 10101101 10111101 11001101 11011101 11101101 01111101 (Binary)

65B block 33_{X} (where 1≦X≦N) is next multiplexed by channel multiplexer 14 and supplied as 65B block 34. Channel multiplexing is realized by taking the logical sum of 65B block 33_{X} (where 1≦X≦N). This is because two or more read requests 36_{X} (where 1≦X≦N) are not generated at the same time, and moreover, because all of the bits of 65B block 33X become “0” if read request 36_{X} is not issued.

65B blocks 34 are sent to CRC operation unit 15, where seven-bit CRC are added to the ends of the blocks and supplied as 72B blocks 35. The CRC generation polynomial is “x⁷+x⁶+x⁵+x²+1”. In addition, the initial value of the CRC operation register is “0.”

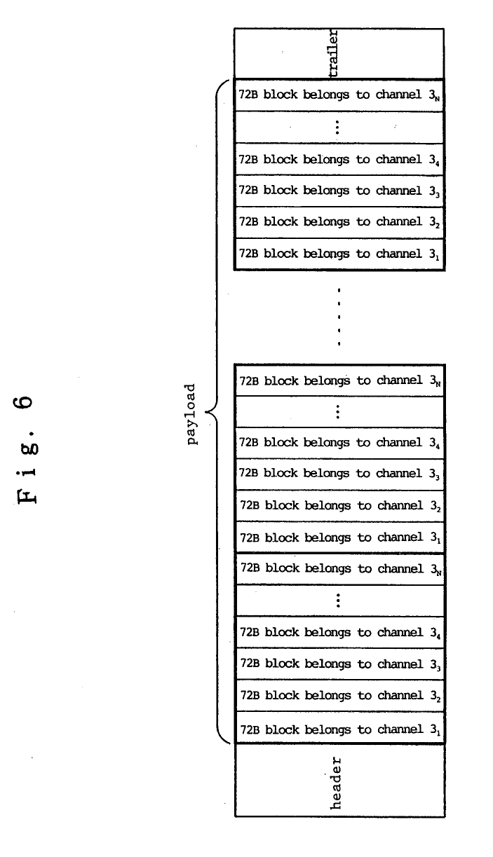

In packet generator 16, 72B blocks 35 are subjected to time division multiplexing in channel units one at a time as shown in FIG. 6 to construct the payload of packets 37. Appropriate headers and trailers are then added before and after the payload to generate packets 37 that can be transmitted on packet transmission path 4. The number of 72B blocks that can be accommodated in a single packet is “B×N” (where B is a natural number). In addition, B is a fixed number that does not vary with each packet. At this time, B must satisfy the following relation:

C×(H+G)/(80×P−72×C×N)≦B≦(M−H)/72/N

where:

C=the maximum rate in bps of 8B/10B bit streams 5₁-5_{N} (not the total but the rate per channel)

P=the minimum bandwidth in bps of packet transmission path 4

H=the length in bits of packet overhead (header and trailer)

G=the minimum spacing between packets in bits

M=the maximum length of a packet in bits

As an example, we will find the value of B when DVB−ASI×4 channels are multiplexed and transmitted on a single gigabit Ethernet line. Since there are four channels 3₁-3_{N}, N=4.

Since the transfer rate of DVB·ASI is 270 Mbps±100 ppm:

C=270×1,000,000×1.0001=270,027,000 bps

Since the bandwidth of a gigabit Ethernet is 1 Gbps±100 ppm;

$$\begin{matrix}P = 1 \times 1 , 000 , 000 , 000 \times 0.9999 \\ = 999 , 900 , 000 bps\end{matrix}$$

In addition, according to Ethernet standards:

$$\begin{matrix}\begin{matrix}H = ( Destination Address ) + ( Source Address ) + ( Length / Type ) + ( Frame Check Sequence ) \\ = 48 + 48 + 16 + 32 = 144 bits\end{matrix} \\ \begin{matrix}G = ( Inter Frame Gap ) + ( Preamble ) + ( Start of Frame Delimiter ) \\ = 96 + 56 + 8 = 160 bits\end{matrix}\end{matrix}$$

M=1518×8=12144 bits

Based on these values, the relation that B should satisfy is:

36.91=B=41.67

In other words, B must take an integral value no less than 37 and no greater than 41.

We next refer to FIG. 3 to explain the details regarding the operation of demultiplex converter 2 shown in FIG. 1.

In 72B block extractor 51, 72B blocks 71 are taken from the payload of packets 70 that have been received from packet receiver 50. Since 72B blocks in a payload are subjected to fixed time division multiplexing as shown in FIG. 6, the relation between 72B blocks 71 and channel numbers 72 is uniquely established.

In CRC detector 52, bit errors are detected by means of the 7-bit CRC that is attached to the end of 72B block 71. Errors may be corrected at this time. Errors that can be corrected are any one-bit error and all two-bit errors in which the error bits are separated by 43 bits. After error detection (or correction), the CRC are removed from 72B blocks 71 and the data are supplied as 65B blocks 73.

In 64B/65B decoder 53, 65B blocks 73 are subjected to 64B/65B decoding and each converted to eight bytes of data 75. In channel separator 54, byte data 75₁-75_{N} are distributed to each channel in accordance with channel numbers 76. Byte data 77_{X} (where 1≦X≦N) that match control code “65B_PAD” are discarded at PAD elimination unit 55_{X}. The remaining byte data 77_{X} is supplied as byte data 78_{X}.

It is next determined in idle elimination unit 56_{X} (where 1≦X≦N) whether byte data 78_{X} can be removed or not. The standard for this determination exists in the protocol of channel 3_{X}. Data are removed such that byte data 78_{X} that violate the protocol of channel 3_{X} do not occur as a result of removal.

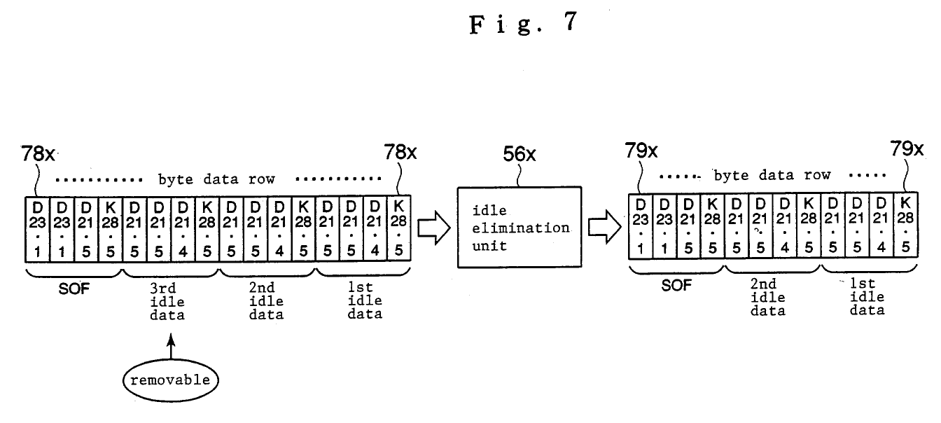

An example of idle data removal is shown in FIG. 7. This figure shows a case for removing one item of idle data of a primitive signal of the fiber channel. In a fiber channel, it is established that at least two items of idle data must be present immediately preceding the SOF (Start-of-frame delimiter). In other words, when three or more items of idle data are present immediately before the SOF, one of these items can be removed without violating protocol.

When data storage amount 80_{X} exceeds the threshold value, byte data 78_{X} that have been determined to be removable are removed. Byte data 78X that cannot be removed are written to rate conversion memory 57_{X} as byte data 79_{X}. One condition in which byte data must be removed is a case in which the clock of channel 3_{X} that is connected to demultiplex converter 2 is slower than the clock of channel 3_{X} that is connected to multiplex converter 1. If all byte data are not removed in such a case, the data storage amount 80_{X} of rate conversion memory 57_{X} continues to increase, eventually resulting in overflow.

In idle insertion unit 58_{X} (where 1≦X≦N), it is determined whether or not another item of byte data can be inserted immediately following byte data 83_{X}. The standard for this determination exists in the protocol of channel 3_{X}. However, byte data are inserted such that byte data 83_{X} that violate the protocol of channel 3_{X} do not occur as a result of insertion.

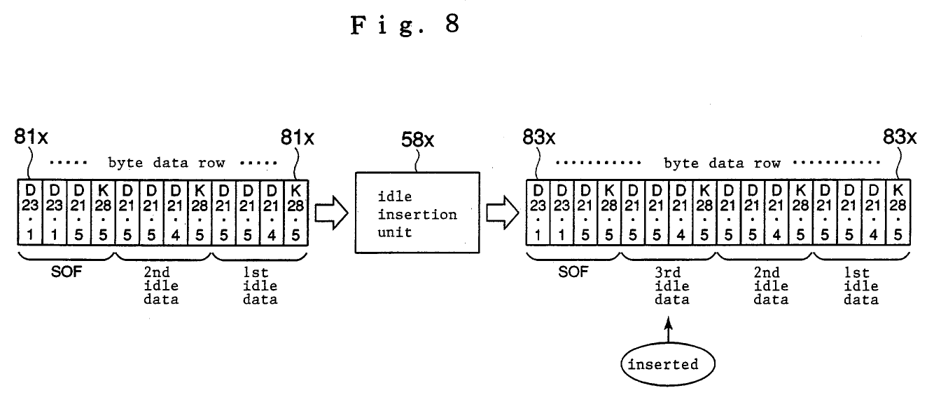

An example of idle data insertion is shown in FIG. 8. In this figure, a case is shown in which one more item of idle data is inserted immediately following two items of idle data in a fiber channel. This operation does not violate protocol for the reasons described hereinabove.

When data storage amount 80_{X} is below the threshold value, appropriate byte data are inserted immediately after byte data 83_{X} where insertion has been determined to be possible. One condition in which byte data must be inserted is a case in which the clock of channel 3_{X} that is connected to demultiplex converter 2 is faster than the clock of channel 3_{X} that is connected multiplex converter 1.

Byte data 83_{X} (where 1≦X≦N) then undergo 8B/10B encoding by 8B/10B encoder 59_{X} to become 10-bit code words 84_{X}. However, when byte data 83_{X} are equivalent to control code “10B_ERR,” a 10-bit pattern that does not conform to 8B/10B code is substituted for code words 84_{X}. In this way, a device that is connected ahead on channel 3_{X} can detect the occurrence of an 8B/10B code violation. Code words 84_{X} (where 1≦X≦N) then undergo serial conversion at serializer 60_{X} to 8B/10B bit stream 6_{X} and are transmitted to channel 3_{X}.

In the multiplex transmission system of the present embodiment, 8B/10B bit streams are converted to a format that can be transmitted on a packet network, whereby an 8B/10B bit stream transmission service can be offered in addition to an ordinary packet transmission service by simply constructing a single packet network. In this way, the lines and equipment of a network can be shared and the efficiency of the use of these lines and equipment can be increased. Further, multiplexing a plurality of 8B/10B bit streams on a single line allows a reduction of the lines and equipment that are required for the transmission of a plurality of 8B/10B bit streams. Still further, according to the multiplex transmission system of the present embodiment, transmission is carried out on the code word level without terminating the host layer of the 8B/10B bit streams, and transmission can therefore be performed while guaranteeing the transparency of the 8B/10B bit streams.

While a preferred embodiment of the present invention has been described using specific terms, such description is for illustrative purposes only, and it is to be understood that changes and variations may be made without departing from the spirit or scope of the following claims.

What is claimed is:

1. A multiplex converting method for multiplexing a plurality of 8B/10B bit streams and converting to packet data, wherein said method comprising the steps of:
converting each of a plurality of 8B/10B bit streams, which are serial signals, to 10-bit parallel signals to produce code words;
subjecting each of these code words to 8B/10B decoding to produce 9-bit byte data;
subjecting each of these items of byte data to 64B/65B encoding to produce 65-bit 65B blocks;
implementing rate conversion of this plurality of 65B blocks, and then multiplexes these 65B blocks to produce a single 65B block;
calculating a 7-bit CRC for this 65B block;
adding this CRC to said 65B block to produce a 72B block; and
adding the necessary overhead for every fixed number of 72B blocks to construct packets and transmits these packets to a packet transmission path.

2. A multiplex converter for multiplexing a plurality of 8B/10B bit streams and converting to packet data, wherein said multiplex converter comprising:
a plurality of deserializers for converting each of the plurality of 8B/10B bit streams, which are serial signals, to respective 10-bit parallel signals and supplying the resulting output as code words;
a plurality of 8B/10B decoders for subjecting the code words from said plurality of deserializers to 8B/10B decoding and supplying the result as 9-bit byte data;
a plurality of 64B/65B encoders for subjecting byte data from said plurality of 8B/10B decoders to 64B/65B encoding and supplying the resulting output as 65-bit 65B blocks;
a plurality of rate conversion memories for first storing each of the 65B blocks from said plurality of 64B/65B encoders, and, upon receiving a read request, sequentially supplying 65B blocks that are stored if 65B blocks are stored, and if 65B blocks are not stored, supplying 65B blocks that include control codes for filling the bandwidth difference;
a channel multiplexer for multiplexing 65B blocks of a plurality of channels that have been supplied as output from said plurality of rate conversion memories to produce one 65 block and supplying the result as output;
a CRC operation unit for calculating 7-bit CRC for 65B blocks from said channel multiplexer, adding this CRC to 65B blocks from said channel multiplexer, and supplying the result as 72B blocks;
a packet generator for both adding necessary overhead to a fixed number of 72B blocks from said CRC operation unit to construct packets and issuing read requests to said rate conversion memories; and
a packet transmitter for controlling physical media and links of packet transmission paths and transmitting packets that have been generated by said packet generator to a packet transmission path.

3. A multiplex converter according to claim 1, wherein said 8B/10B bit streams are fiber channel signals.

4. A multiplex converter according to claim 2, wherein said 8B/10B bit streams are fiber channel signals.

5. An demultiplex converting metho for separating and restoring 8B/10B bit streams from packet data that have been multiplexed by a multiplex converter; said method comprising the steps of:
removing overhead from packets that have been received from a packet transmission path to extract 72B blocks;
using CRC that are added to these 72B blocks to detect bit errors, and then subjecting the 65B blocks that are obtained by eliminating CRC from said 72B blocks to 64B/65B decoding to obtain byte data;
distributing these byte data according to channel number to produce a plurality of items of byte data that correspond to each of a plurality of channels;
determining whether this plurality of items of byte data match control codes for filling bandwidth difference, and removing byte data when matching occurs;
regulating the rate of said plurality of byte data by removing byte data that can be removed without causing protocol problems or inserting byte data that can be inserted without causing protocol problems;
subjecting the byte data that have undergone rate regulation to 8B/10B encoding to generate code words; and
subjecting each of these code words to serial conversion and then supplying the result to each channel as 8B/10B bit streams.

6. An demultiplex converter for separating and restoring 8B/10B bit streams from packet data that have been multiplexed by a multiplex converter; said demultiplex converter comprising:
a packet receiver for controlling links and physical media of a packet transmission path and receiving packets from said packet transmission path;
a 72B block extractor for removing overhead from packets that have been received by said packet receiver to extract 72B blocks, and supplying as output these 72B blocks together with channel numbers, which are the numbers of channels to which these 72B blocks belong;
a CRC detector for using CRC that have been added to 72B blocks from said 72B block extractor to detect bit errors and then supplying as output 65B blocks, which are obtained by removing CRC from 72B blocks, and channel numbers, which are the numbers of channels to which these 65B blocks belong;
a 64B/65B decoder for subjecting 65B blocks from said CRC detector to 64B/65B decoding and supplying the result as byte data and channel numbers;
a channel separator for distributing byte data from said 64B/65B decoder in accordance with the channel numbers and supplying the result as a plurality of items of byte data that correspond to said plurality of channels;
a plurality of PAD elimination units for determining whether or not the plurality of items of byte data from said channel separator matches control codes for filling bandwidth differences and, when matching occurs, eliminating the matching byte data;
a plurality of idle elimination units for eliminating byte data for which elimination causes no protocol problems when a data storage amount that is reported from the outside exceeds a predetermined threshold, and supplying the remaining byte data as output;
a plurality of rate conversion memories for first storing each of the items of byte data from said idle elimination units and, upon receiving a read request, both sequentially supplying byte data that are stored as output and reporting the current data storage amount to said idle elimination units;
idle insertion units for, when the data storage amount from said rate conversion memories falls below a predetermined threshold, both inserting byte data whose insertion does not cause protocol problems into byte data from said rate conversion memories and, while inserting these byte data, halting the issuance of read requests to said rate conversion memories;
a plurality of 8B/10B encoders for subjecting byte data from said idle insertion units to 8B/10B encoding to generate code words; and
a plurality of serializers for subjecting code words from said plurality of 8B/10B encoders to serial conversion and supplying the result as 8B/10B bit streams to each channel.

7. An demultiplex converter according to claim 5, wherein said 8B/10B bit streams are fiber channel signals.

8. An demultiplex converter according to claim 6, wherein said 8B/10B bit streams are fiber channel signals.
